(19) United States
(12) Patent Application Publication
(10) Pub. No.: US 2006/0138279 A1
(43) Pub. Date: Jun. 29, 2006

(54) Aircraft floor panel

(76) Inventor: Nathan Pisarski, Stow, OH (US)

Correspondence Address: Cynthia S. Murphy;Renner, Otto, Boisselle & Sklar, LLP, Nineteenth Floor, 1621 Euclid Avenue, Cleveland, OH, 44115, US

(21) Appl. No.: 11/270,395

(22) Filed: Nov. 9, 2005

Related U.S. Application Data
(60) Provisional application No. 60/662,200, filed on Mar. 16, 2005.
(60) Provisional application No. 60/638,601, filed on Dec. 23, 2004.

(51) Int. Cl. B64D 11/00

(52) U.S. Cl. 244/118.5

(57) ABSTRACT

An aircraft floor panel (10) for installation in a to-be-heated area of an aircraft. The panel (10) comprises a panel-supporting level (20), a heat-generating level (22), and an upper level (24) having an upper surface (26) that forms the uppermost surface (18) of the panel (10). A thermally conductive layer (60) within the upper level (24) comprises strength-imparting elements (64) embedded in a matrix (66). This layer (60) provides the primary impact-resistance for the panel (10) and also serves as its heat-distributing layer.

### RELATED APPLICATION

This application claims priority under 35 U.S.C. §119(e) to U.S. Provisional Patent Application No. 60/662,200 filed on Mar. 16, 2005 and to U.S. Provisional Patent Application No. 60/638,601 filed on Dec. 23, 2004. The entire disclosures of these provisional applications are hereby incorporated by reference.

### FIELD OF THE INVENTION

This invention relates generally to an aircraft floor panel and, more particularly, to a floor panel for installation in an area of an aircraft that is to be heated during flight.

### BACKGROUND OF THE INVENTION

A heated aircraft floor panel generally comprises a lower panel-supporting level, a heat-generating level, and an upper impact-resisting level. The top surface of the impact-resisting level forms the uppermost surface of the panel and directly receives floor-traffic-related impacts (e.g., high heels, dropped objects, dragged luggage, etc.). To insure the integrity of the floor panel, it is important that the heat-generating level be protected from such impacts. Accordingly, an aircraft floor panel, and particularly its impact-resisting level, are designed to withstand a certain amount of impact energy (i.e., a qualification mean energy value) without sacrificing insulation resistance and/or suffering from surface penetration.

### SUMMARY OF THE INVENTION

The present invention provides an aircraft floor panel wherein the upper impact-resisting level includes a thermoset thermal-distributing layer that provides the primary impact-resistance for the panel.

More particularly, the present invention provides an aircraft floor panel for installation in an area of an aircraft that is to be heated during flight. The panel comprises a heat-generating level and an upper level that resists impacts and distributes heat. The upper level comprises a thermally-conductive primary layer including strength-imparting elements embedded in a matrix. This primary layer withstands at least 90% of the panel's qualification mean energy value (e.g., at least 3.0 joules).

The thermally-conductive and strength-imparting elements can be wires, rods, shafts, fibers, or particles. The elements can be assembled in a mesh, a screen, or a fabric, and/or they can be made of a metal or metal alloy (e.g., stainless steel, titanium, copper, aluminum). The element-embedding matrix can comprise a thermoset polymer and/or a thermally conductive material (e.g., a thermally conductive adhesive and/or a thermally conductive polymer).

The upper impact-resisting level can additionally comprise a skin layer positioned over the primary layer and this skin layer can be characterized by the absence of any strength-imparting elements. Such a skin layer can have a thickness of about 0.025 inch or less. Accordingly, if the skin layer forms the top layer of the panel and the primary layer is positioned just below the skin layer, the strength-imparting elements will be positioned 0.025 inch or less from the panel's uppermost surface.

The heat-generating level and the upper impact-resisting level can be formed as a composite structure. Moreover, the panel can include a lower panel-supporting level (e.g., a honeycomb layer sandwiched between fiber reinforced polymer layers) and this lower level, the heat-generating level and the upper impact-resisting level can form a composite structure. If so, the aircraft floor panel can be made by compiling the panel-supporting level, the heat-generating level, a matrix-forming layer, and the strength-imparting elements together, and then curing the compiled materials together to form the composite structure. If the upper level includes a skin layer, the primary layer and the skin layer can be co-cured and form part of the composite structure.

These and other features of the invention are fully described and particularly pointed out in the claims. The following descriptive annexed drawings set forth in detail a certain illustrative embodiment of the invention, this embodiment being indicative of but one of the various ways in which the principles of the invention may be employed.

### DRAWINGS

FIG. 1 is a schematic perspective view of an aircraft floor panel according to the present invention installed in an aircraft.

FIG. 2 is a cross-sectional view of the aircraft floor panel.

FIG. 3 is a schematic diagram of a heater layer of the floor panel.

FIG. 4 is a cross-sectional view of the heater layer as see along lines 4-4 of FIG. 3.

FIG. 5 is a top view of a primary impact-resisting layer of the floor panel.

FIG. 6 is a top view of another primary impact-resisting layer of the floor panel.

FIG. 7 is a top view of another primary impact-resisting layer of the floor panel.

FIGS. 8A-8C are schematic views of a method of making the aircraft floor panel.

### DETAILED DESCRIPTION

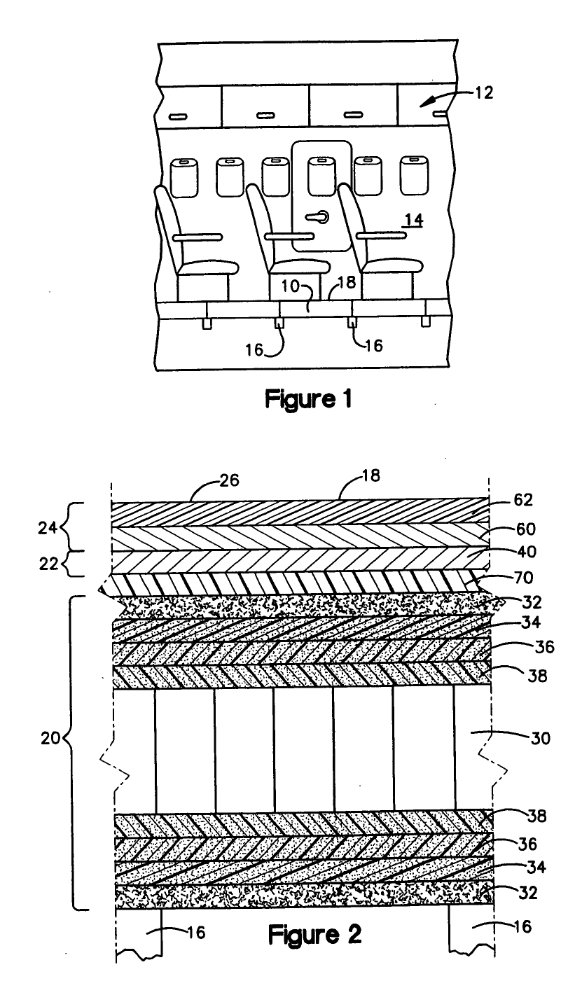

Referring now to the drawings, and initially to FIG. 1, an aircraft floor panel 10 according to the present invention is shown installed in an aircraft 12. The floor panel 10 is provided in order to maintain an area 14 (e.g., the cabin) at a comfortable temperature and, to this end, is a heated floor panel. The aircraft 12 includes structural members 16 below the area 14 by which the panel 10 is supported. It may be noted for future reference that the uppermost surface 18 of the panel 10 receives the brunt of floor-traffic impacts (e.g., high heels, dropped objects, dragged luggage, etc.).

Referring now to FIG. 2, the aircraft floor panel 10 is shown in detail. The panel 10 comprises a panel-supporting level 20, a heat-generating level 22, and an upper impact-resisting level 24. The supporting level 20 is mounted to the aircraft structural members 16 below the area 14 and the heat-generating level 22 generates heat. The upper surface 26 of the level 24 forms the uppermost surface 18 of the panel 10, and thus receives (and resists) impacts caused by floor traffic in the area 14. As is explained in more detail below, the upper level 24 also distributes generated heat to the area 14 whereby it is also a heat-distributing level.

The illustrated supporting level 20 comprises a honeycomb layer 30 sandwiched between layers 32, 34, 36, and 38. A suitable honeycomb material is ECA-1/8-7.7(3)-.285 ThK available from Eurocomposites and an epoxy core filler (such as EC 631 FST also available from Eurocomposites) may be used. The sandwiching layers 32, 34, 36, and 38 can each comprise a prepreg layer, that is a fiber reinforced polymer layer formed of a plurality of filamentary materials (e.g., fiberglass, carbon, aramid) in a matrix of thermoset polymeric material (e.g., phenolic, epoxy). For example, the layers can comprise fiberglass/phenolic prepreg layers 32, carbon/phenolic prepreg layers 34, and prepreg carbon/epoxy layers 36 and 38. These prepreg layers are available from Stesalit AG (Zullwill Switzerland) as PF801-44-53, PF801-C15-50, and EP121-C15-53, respectively.

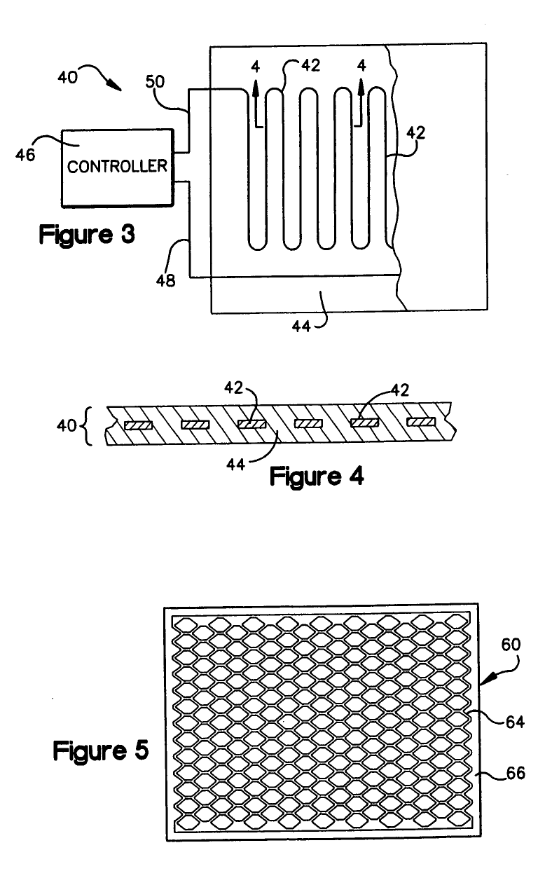

The heat-generating level 22 can comprise a heater layer 40. As is best seen in FIGS. 3 and 4, the heater layer 40 can comprise an electric heater element 42 and a dielectric material 44, in which the heater element 42 is encapsulated. The element 42 may be an etched foil type element or a resistance wire element made of an electrically conductive material (e.g., metal). For example, the heating element 42 can comprise a foil layer of Cupron (a nickel alloy available from Amax Specialty Metals Corp). As is shown schematically in FIG. 3, the heater element 42 heats up when a current is applied by a controller 46 via lines 48 and 50.

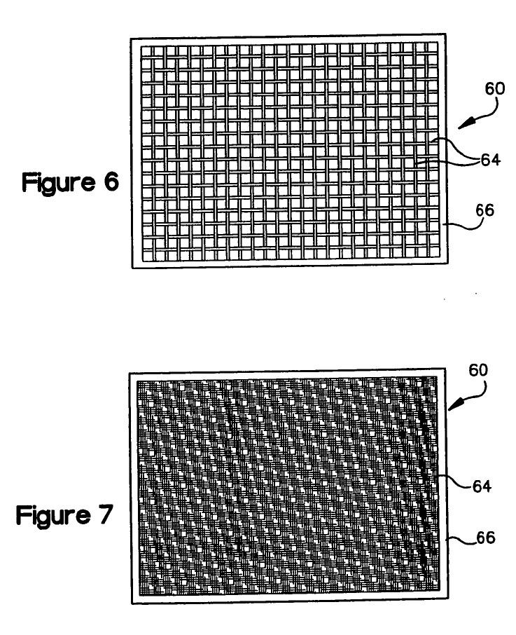

The impact-resisting level 24 comprises a primary layer 60 and a surfacing skin layer 62. As is best seen in FIGS. 5-7, the primary layer 60 comprises strength-imparting elements 64 embedded in a thermoset polymer matrix 66. The elements 64 can comprise wires, rods, shafts, particles, fibers or other rigid objects and they can be arranged, assembled, or aggregated in a strength-imparting manner. For example, the elements 64 can be assembled in a mesh (FIG. 5), a screen (FIG. 6), or a weave (FIG. 7). The shape and size of the respective elements 64, and the collective geometry, density and direction of the elements 64, are selected to best absorb floor-traffic impacts while still meeting other design factors (e.g., weight).

The strength-imparting elements 64 and/or the matrix 66 are preferably thermally conductive whereby the primary layer 60 is also a heat-distribution layer. Thermally conductive in the context of the present application refers to a thermal conductivity at least greater than about 10.0 W/mK. Preferably, the thermal conductivity of the primary layer 60 is greater than about 20.0 W/mk, greater than about 30.0 W/mK, greater than about 40 W/mk, and/or greater than about 50 W/mK.

If the strength-imparting elements 64 are thermally conductive, they can comprise metal/alloy elements (e.g., stainless steel, titanium, copper, aluminum, etc.), elements with nonmetal cores and metal coating (e.g., metallized fiberglass), and/or graphite elements. Suitable strength-imparting and thermally-conductive elements 64 include woven metal filter cloths (offered by TWP Inc. of California), filtering wire meshes (also offered by TWP Inc.), and/or expanded metal (offered by Dexler Corporation of Connecticut). Stainless steel (e.g., 316 or 317 stainless) offers adequate corrosion resistance, an overall thickness of 0.007 to 0.011 allows a desirable blend/embed in the matrix material, a relative tight pattern (e.g., 100×100 elements/inch or 120×400 elements/inch) provides strength/impact resistance while still allowing the flow of matrix-forming resin therethrough.

If the matrix 66 is additionally or alternatively thermally conductive, it can comprise a thermally conductive adhesive (e.g., epoxy) or a thermally conductive polymer (e.g., polyester, BMI, phenolics).

The skin layer 62 can comprise a surfacing film and, more particularly, a relatively low-resin surfacing film that replicates a tool surface with constant thickness. The skin layer 62 can be selected to also protects the underlying layers from typical forms of stripping/sanding operations and/or to withstand repeated paint stripping operations. The skin layer 62 can be characterized by the absence of strength-imparting elements and will typically have a thickness of less than about 0.025 inch, less than about 0.020 inch, less than about 0.015 inch, and/or less than about 0.010 inch. Thus, when the skin layer 62 forms the upper surface 26 of the level 24 and when the primary layer 60 is positioned just below the skin layer 62, the strength-imparting elements 64 will be positioned within at least 0.025 inch from the uppermost surface 18 of the panel 10. A suitable surfacing film is Loctite Synskin, an epoxy-based material with or without an electrically conductive (i.e., copper or aluminum) mesh.

The upper impact-resisting level 24 protects the heat-generating level 22 (and the rest of the panel 10) from floor-traffic related impacts and thus is designed to withstand a certain amount of impact energy without sacrificing insulation resistance and/or surface penetration. Specifically, the level 24 has a qualification mean energy value for insulation resistance failure and surface penetration that is at least 3.0 joules, is at least 4.0 joules, is at least 5.0 joules, and/or at least 6.0 joules, as measured by ASTM D-5420-98a. (Impact Resistance of Flat, Rigid, Plastic Specimen by Means of a Striker Impacted by a Falling Weight (Garner Impact)). The layer 60 provides the primary impact resistance and can withstand at least 80%, at least 85%, at least 90%, at least 93%, at least 96%, and/or at least 99% of this energy value. The skin layer 62 (and/or other optional layers of the level 24) do not contribute significantly to the impact-resistance of the panel 10.

An adhesive layer 70 is positioned between the supporting level 20 and the heat-generating level 22 and bonds these levels 20/22 together. The adhesive layer 70 can comprise a film adhesive (e.g., epoxy) capable of withstanding elevated curing temperatures such as, for example, the epoxy film adhesive sold as AF-126 from 3M. The adhesive layer 70 may incorporate a scrim (not shown) if necessary or desired for adhesive-spreading purposes.

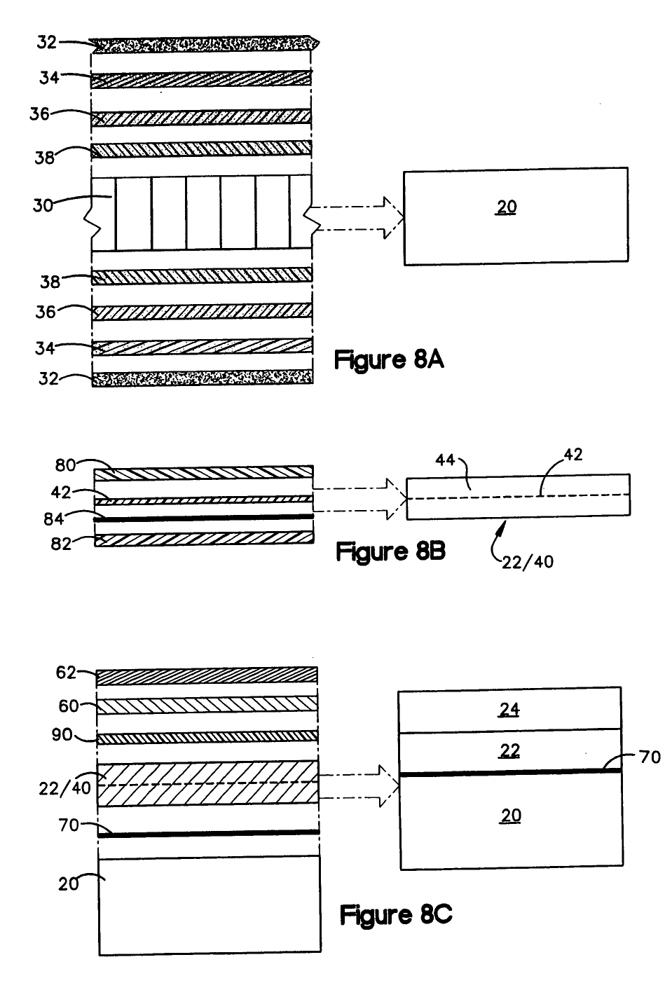

Referring now to FIGS. 8A-8C, a method of making the aircraft floor panel 10 is schematically shown. In this method, the honeycomb layer 30 and the sandwiching layers 32, 34, 36 and 38 are compiled together and cured to form the supporting level 22. (FIG. 8A.) The curing can be performed at an elevated temperature (e.g., 280° F.) at a suitable pressure (e.g., 60 psi) for an appropriate period of time (e.g., 90 minutes). Debulking may be necessary thereafter.

The heat-generating level 22 (i.e., the heater layer 40) is separately formed by disposing the heater element 42 between thermosettable plies 82 and 84 (e.g., a polyamide film ply and an acrylic/polyamide film ply). An acrylic adhesive 86 can be used for pre-curing attachment of the heating element 42 to one of the thermosettable plies 82/84. (FIG. 8B.) The curing can be performed at an elevated temperature (e.g., 375° F.) at a suitable pressure (e.g., 120 psi) for an appropriate period of time (e.g., 60 minutes).

The panel-supporting level 20, the adhesive layer 70, the heat-generating level 22, a matrix-forming layer 90 (i.e., an adhesive film), the strength-imparting elements 64, and the skin layer 62 are then compiled together and cured. (FIG. 8C.) The curing can be performed at an elevated temperature (e.g., 250° F.) at a suitable pressure (e.g., 40 psi) for an appropriate period of time (e.g., 60 minutes).

During the final curing step, the strength-imparting elements 64 are embedded in the matrix-forming layer 90, thereby forming the matrix 66, and the skin layer 62 is bonded to the matrix 66. Also, the panel-supporting level 20 and the heat-generating level 22 are bonded together, and the heat-generating level 22 and the upper level 24 are bonded together. Thus, the levels 20, 22 and 24 of the panel 10 form a composite structure.

One may now appreciate that the present invention provides an aircraft floor panel wherein the upper impact-resisting level includes a thermoset thermally conductive layer that provides the primary impact-resistance for the panel. Although the invention has been shown and described with respect to a certain preferred embodiment, it is obvious that equivalent and obvious alterations and modifications will occur to others skilled in the art upon the reading and understanding of this specification. The present invention includes all such alterations and modifications and is limited only by the scope of the following claims.

1. An aircraft floor panel for installation in an aircraft, said panel comprising:
a heat-generating level for generating heat, and
an upper level for resisting impacts caused by floor traffic in a to-be-heated area of the aircraft and for distributing the generated heat to this area;
wherein the upper level comprises a thermally conductive primary layer including strength-imparting elements embedded in a matrix; and
wherein the upper level has a qualification mean energy value for insulation resistance failure and surface penetration that is at least 3.0 joules and wherein the primary layer withstands at least 90% of the qualification mean energy value.

2. An aircraft floor panel as set forth in claim 1, wherein the strength-imparting elements are thermally conductive.

3. An aircraft floor panel as set forth in claim 2, wherein the matrix comprises a thermally conductive material.

4. An aircraft floor panel as set forth in claim 3, wherein the matrix comprises a thermally conductive adhesive and/or a thermally conductive polymer.

5. An aircraft floor panel as set forth in claim 1, wherein the matrix comprises a thermally conductive material.

6. An aircraft floor panel as set forth in claim 5, wherein the matrix comprises a thermally conductive adhesive and/or a thermally conductive polymer.

7. An aircraft floor panel as set forth in claim 1, wherein the upper level has an upper surface that forms the uppermost surface of the panel.

8. An aircraft floor panel as set forth in claim 7, wherein the strength-imparting elements are positioned 0.025 or less from the panel's uppermost surface.

9. An aircraft floor panel as set forth in claim 1, wherein the heat-generating level and the upper level form a composite structure.

10. An aircraft floor panel as set forth in claim 1, wherein the upper level additionally comprises a skin layer positioned over the primary layer, wherein the skin layer is characterized by the absence of any strength-imparting elements and/or wherein the skin layer has a thickness of about 0.025 inch or less.

11. An aircraft floor panel as set forth in claim 10, wherein the primary layer and the skin layer form part of a co-cured composite structure.

12. An aircraft floor panel as set forth in claim 1, wherein the strength-imparting elements are wires, rods, shafts, fibers, or particles.

13. An aircraft floor panel as set forth in claim 12, wherein the matrix comprises a thermoset polymer which embeds the strength-imparting elements.

14. A method of making the aircraft floor panel set forth in claim 1, said method comprising the steps of:
compiling a panel-supporting level, the heat-generating level, a matrix-forming layer, and the strength-imparting elements together; and
curing the compiled materials together to form a composite structure.

15. A method as set forth in claim 14, wherein said curing step is performed at an elevated temperature.

16. A method as set forth in claim 14, further comprising the step of making the panel-supporting level by sandwiching a honeycomb layer between fiber reinforced polymer layers and then curing the layers.

17. In combination, an aircraft and an aircraft floor panel as set forth in claim 1 installed in an area of the aircraft.

18. An aircraft floor panel comprising a heat-generating level and an upper heat-distributing/impact-resisting level;
the upper level including a primary layer and a skin layer positioned above the primary layer and forming the panel's uppermost surface;
the primary layer including strength-imparting elements embedded in a matrix;
the strength-imparting elements and/or the matrix being thermally conductive;
the skin layer being characterized by the absence of any strength-imparting elements.

19. An aircraft floor panel as set forth in claim 18, wherein the strength-imparting elements are metal elements and the matrix is a thermoset matrix.

20. An aircraft floor panel comprising a heat-generating level and an upper heat-distributing/impact-resisting level;
the upper level having an upper surface forming the panel's uppermost surface;
the upper level comprising a thermally conductive primary layer including metal elements embedded in a thermoset matrix;
the metal elements being positioned 0.025 or less from the panel's uppermost surface.
